(19) United States
(12) Patent Application Publication
(10) Pub. No.: US 2014/0312208 A1
(43) Pub. Date: Oct. 23, 2014

(54) DRIVE CIRCUIT FOR SEMICONDUCTOR IMAGE SENSOR ARRAY

(71) Applicant: CANON KABUSHIKI KAISHA, Tokyo (JP)

(72) Inventor: Akehiko Uchiyama, Kawasaki-shi (JP)

(21) Appl. No.: 14/318,866

(22) Filed: Jun. 30, 2014

Related U.S. Application Data
(63) Continuation of application No. 12/621,500, filed on Nov. 19, 2009, now abandoned.

(30) Foreign Application Priority Data
Nov. 20, 2008 (JP) 2008-296805

(51) Int. Cl. H04N 5/376

(52) U.S. Cl. CPC H04N 5/376
USPC 250/208.1

(57) ABSTRACT

A refresh control line GR (n) is selected while a read control line GT (n+1) or a read control line GT (n−1), which controls a read switch of a pixel of a semiconductor image sensor array is selected. This configuration allows the read and refresh operations or the refresh and read mode setting operations to be performed simultaneously, and reduces the period for scanning the semiconductor image sensor array.

### CROSS-REFERENCE TO RELATED APPLICATION

This application is a Continuation of U.S. application Ser. No. 12/621500, filed Nov. 19, 2009, which claims priority from Japanese Patent Application No. 2008-296805 filed Nov. 20, 2008, which are hereby incorporated by reference herein in their entireties.

### BACKGROUND OF THE INVENTION

1. Field of the Invention

The present invention relates to a drive circuit for semiconductor image sensor array suitable for use in a radiation detecting apparatus in a medical imaging system and a non-destructive inspection system.

2. Description of the Related Art

In observing and imaging an object using radiation, especially in capturing moving images, an X-ray camera is used, which is provided with an image intensifier (I.I.) and a camera for capturing (shooting) visible light images. In the X-ray camera, the intensity information of an X-ray image is intensified by the image intensifier and converted into a visible light image, which is captured (shot) by the visible light camera. The visible light camera had a camera tube therein at an initial stage as an image sensor, and the tube was already replaced with a solid-state image sensor such as charge-coupled device (CCD).

In the X-ray camera with I. I., an X-ray image is projected on an X-ray image reception area and converted into a visible light image by the I. I., which is then received on an image reception area of the camera and converted into video signals. Between the two image reception areas are provided with electron lenses for the I. I. and visible light lenses for the visible light camera. These optical systems significantly reduce the size of the image reception area of the camera as compared to that of the X-ray image reception area. These optical systems, however, have problems of the image distortion that is inevitably caused by aberration of electron lens of I. I. and disturbance from outer electromagnetic field, and the increased size and weight of the X-ray camera.

To avoid the problems of the image distortion and the camera size caused by the electron lens, it is required to omit the optical systems and to directly convert the X-ray image intensity into electrical signals at the X-ray image reception area. In recent years, in view of the above situation, X-ray detectors having a wide viewing angle has been proposed and in practical use. Especially, a radiation detector using a flat panel detector (FPD) the size of which is equal to or larger than an object has been used, at first in still image shooting, and is now expected to be used in a moving image shooting apparatus.

An FPD has been proposed, which includes a glass substrate, and photoelectric conversion elements and thin-film-transistors (TFTs) made of amorphous silicon or polysilicon deposited on the substrate, the elements and TFTs being two dimensionally arranged as a plurality of pixels.

FIG. 6 is a block diagram illustrating the pixel arrays of an FPD. A number of pixels 10 are two dimensionally arranged as arrays, and each of the pixels 10 is connected with two switching devices of TFTs. For example, a first switching device is a read switch 12 connecting the pixel 10 to a reading line 11, and a second switching device is a refresh switch 14 connecting the pixel 10 to a refresh voltage line 13.

The pixels 10 each have an upper electrode, which is connected to a common bias voltage source 16 through bias power lines 15. The pixels 10 each have a lower electrode connected to the read switch 12 and the refresh switch 14. The lower electrode is connected to refresh voltage line 13 by switching on the read switch 12 or the refresh switch 14.

The read switches 12 are controlled by a shift register 17 through a read control line GT on a row-by-row basis. The read switches 12 in a row are turned on/off simultaneously. Similarly, the refresh switches 14 are controlled by a shift register 18 through a refresh control line GR on a row-by-row basis. The refresh switches 14 in a row are turned on/off simultaneously.

The pixel 10 enters a photoelectric conversion mode when the refresh switch 14 is turned off and the read switch 12 is turning off. With the reading line 11 being held at ground (GND) potential, a bias voltage is applied to the pixel 10 from a bias voltage source 16 so that the upper electrode has positive polarity. After the application of a bias voltage, even if the read switch 12 is turned off, the capacity (not illustrated) is available to apply an electric field to the pixel 10 to keep the pixel 10 in the photoelectric conversion mode.

In the photoelectric conversion mode, the read switch 12 is turned on again to measure an amount of incident light. This causes an amount of the electrons corresponding to the hole carriers stored at the insulation layer interface of the pixel 10 in the photoelectric conversion mode to flow into the pixel 10 via the reading line 11 and the read switch 12. More specifically, a current flows from the pixel 10 to the reading line 11, which is measured as the amount of incident light.

The pixel 10 enters a refresh mode when the read switch 12 is turned off and the refresh switch 14 is turned on. A refresh voltage source 19 outputs a higher voltage than the bias voltage source 16, and thereby a difference voltage between a refresh voltage and a bias voltage is applied to the pixel 10 so that the lower electrode has positive polarity.

FIG. 7A illustrates a read operation on a row n, whereas FIG. 7B illustrates a refresh operation on the row n.

As illustrated, although a plurality of reading lines 11 are provided, the read and refresh operations cannot be performed simultaneously.

The read switch 12 and the refresh switch 14 are thus controlled by selecting a row by the shift registers 17 and 18. Accordingly, the pixels in the selected row shift to the photoelectric conversion mode or the refresh mode simultaneously.

FIGS. 8A and 8B illustrate a cross section of a panel structure of the pixel 10, and an energy band of the pixel 10 in an unbiased state, respectively. The pixel 10 includes a glass substrate 21 of insulative material, and various materials deposited on the substrate 21.

An upper electrode 22 is transparent, and a lower electrode 23 is formed of Al or Cr. An insulation layer 24 includes an amorphous silicon nitride film to block both electrons and holes.

An intrinsic semiconductor layer 25 of hydrogenated amorphous silicon generates an electron hole pair based on incident light, and serves as a photoelectric conversion layer. An impurity-doped semiconductor layer 26 is formed of N+ amorphous silicon, and serves as a hole blocking layer that blocks the injection of a hole from the upper electrode 22 to the intrinsic semiconductor layer 25.

FIGS. 9A, 9B, and 9C illustrate the operations of the pixel 10. The pixel 10 is switched between a photoelectric conversion mode and a refresh mode. In the photoelectric conversion mode, as illustrated in FIG. 9A, a bias voltage is applied across the upper electrode 22 and the lower electrode 23, so that an upper electric field becomes positive polarity.

The bias voltage causes the electrons at the intrinsic semiconductor layer 25 to be expelled from the upper electrode 22. On the other hand, holes are injected from the upper electrode 22 toward the intrinsic semiconductor layer 25, which are blocked by the impurity-doped semiconductor layer 26 and do not reach the intrinsic semiconductor layer 25.

In this state, as illustrated in 9B, an electron hole pair is generated based on the light incident on the intrinsic semiconductor layer 25. The electron hole pair is influenced by the electric field, and the separated electron and hole independently move in the opposite directions without recombination. The electron is expelled from the upper electrode 22, and the hole is blocked by the insulation layer 24 and remains at the interface thereof.

As the photoelectric conversion operation is continued, the number of the holes remaining at the interface of the insulation layer 24 is increased, which causes the electric field applied to the intrinsic semiconductor layer 25 to be reduced. Consequently, the electron hole pair generated based on the incident light is recombined without moving due to the electric field, resulting in that the pixel 10 loses sensitivity to light. FIG. 9C illustrates the energy band in this state, which is called saturation.

In the refresh mode, as illustrated in FIG. 9C, a refresh voltage is applied across the upper electrode 22 and the lower electrode 23, and the refresh voltage is applied to a lower electric field so that the lower electric field becomes positive polarity. The shift of the pixel 10 from the photoelectric conversion mode to the refresh mode causes the holes remaining at the interface of the insulation layer 24 to be expelled to the upper electrode 22, and instead the electrons to be injected to remain at the interface of the insulation layer 24. This cancels the above described saturation.

Another shift of the pixel 10 to the photoelectric conversion mode of FIG. 9A causes the electrons injected by the refresh to be quickly expelled from the upper electrode 22, resulting in the pixel 10 applied with a bias voltage. In this way, the pixel 10 is regularly switched between the refresh mode and the photoelectric conversion mode to maintain its sensitivity to light.

FIG. 10 is a timing chart illustrating a read scan of an FPD using a shift register. The timing chart illustrates the scan of rows (n−1) to (n+1).

First, a read control line GT (n−1) is connected, so that the read switches 12 in a row (n−1) are turned on, to read light signals stored in the pixels 10 in the row (n−1). Then the read control line GT (n−1) is disconnected, and a refresh control line GR (n−1) is connected instead, so that the refresh switches 14 in the row (n−1) are turned on, to refresh the pixels 10 in the row (n−1).

Next, the refresh control line GR (n−1) is disconnected, and the read switches 12 are pulsed on, which causes each of the pixels 10 in the row (n−1) to enter the photoelectric conversion mode. Here, the read and refresh operations on the row (n−1) are completed. Each of the pixel 10 in the row (n−1) is held in the photoelectric conversion mode until next refresh.

The above operations performed on the row (n−1) are then performed on a row (n). In this way, the same operations are repeated over the entire surface of the pixel 10 to complete the reading and refresh of the arrays of the pixels 10. When the scan of the last row is completed, the pixels 10 are all in the photoelectric conversion mode. Thus, any light signal incident after the scan is read by the next scan. Such FPD is discussed in Japanese Patent Application Laid-Open No. 2007-104219.

As described above, an FPD with pixels each having two switches has been discussed, and is starting to be used for dynamic radiographic imaging.

In the above FPD, the irradiation of X-ray pulses is desirably implemented between the scans when the entire arrays are in the photoelectric conversion mode. The irradiation of high brightness X-ray in a short period of time, however, places burden on the X-ray tube. Thus, there is a need for an increased scan rate to prolong an X-ray irradiation period and to achieve an improved frame rate.

### SUMMARY OF THE INVENTION

The present invention is directed to a drive circuit for semiconductor image sensor array, which improves a scan rate.

A drive circuit for semiconductor image sensor array according to an aspect of the present invention includes read switches (x, y) each connected to every pixel (x, y) of the semiconductor image sensor array, a read control line (x) controlling all of the read switches along the y coordinate for a certain x coordinate simultaneously, refresh switches (x, y) each connected to every pixel (x, y) as pairs with the read switches 12 (x, y), a refresh control line (x) controlling all of the refresh switches along the y coordinate for a certain x coordinate simultaneously, a read-control-line drive circuit configured to drive the read control line (x), and a refresh-control-line drive circuit configured to drive the refresh control line (x), wherein the read-control-line drive circuit selects to drive a read control line GT (x), selects to drive a read control line GT (x−m: m is a natural number), and then selects to drive a read control line GT (x+m), which is a first set to be repeatedly operated in succession.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates an example circuit configuration of an FPD according to an exemplary embodiment of the present invention.

FIGS. 2A and 2B illustrate the principle of the present invention.

FIG. 3 is a timing chart of operations.

FIG. 4 illustrates a bidirectional shift register.

FIG. 5 is a timing chart of a shift register.

FIG. 6 is a block diagram illustrating a conventional FPD.

FIGS. 7A and 7B illustrate the principle of the present invention.

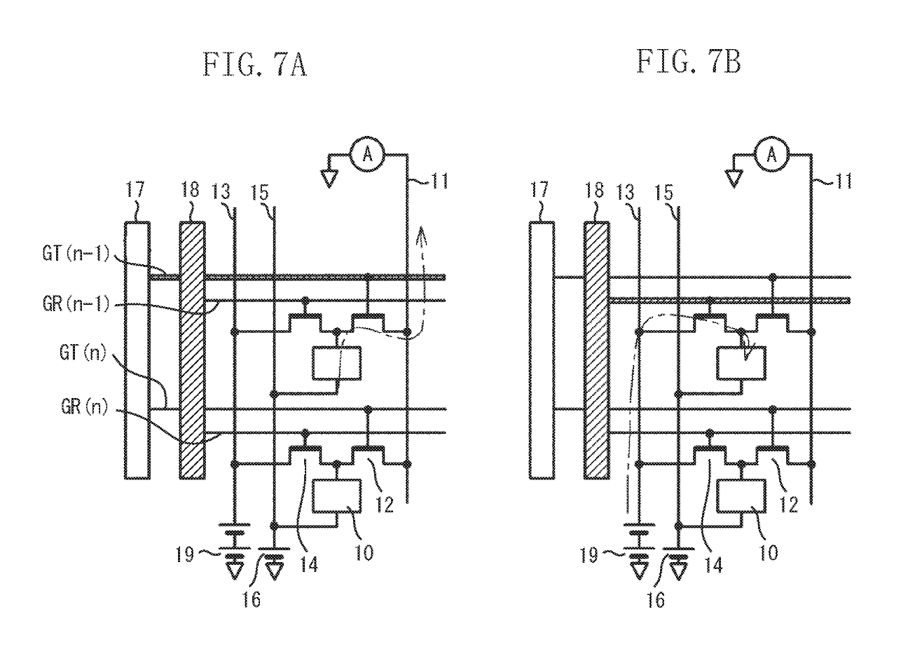

FIGS. 8A and 8B illustrate a pixel configuration and an energy band of the pixel.

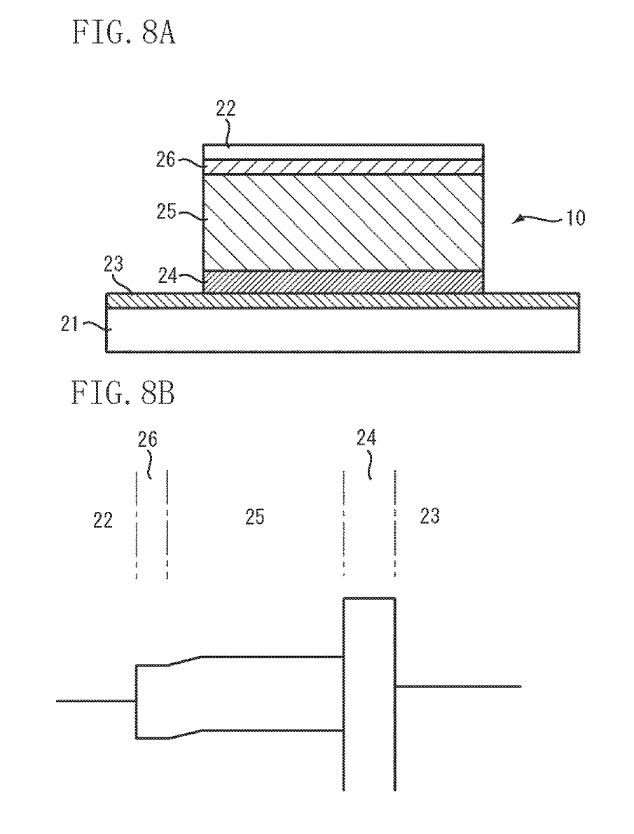

FIGS. 9A, 9B, and 9C illustrate an energy band during an operation on a pixel.

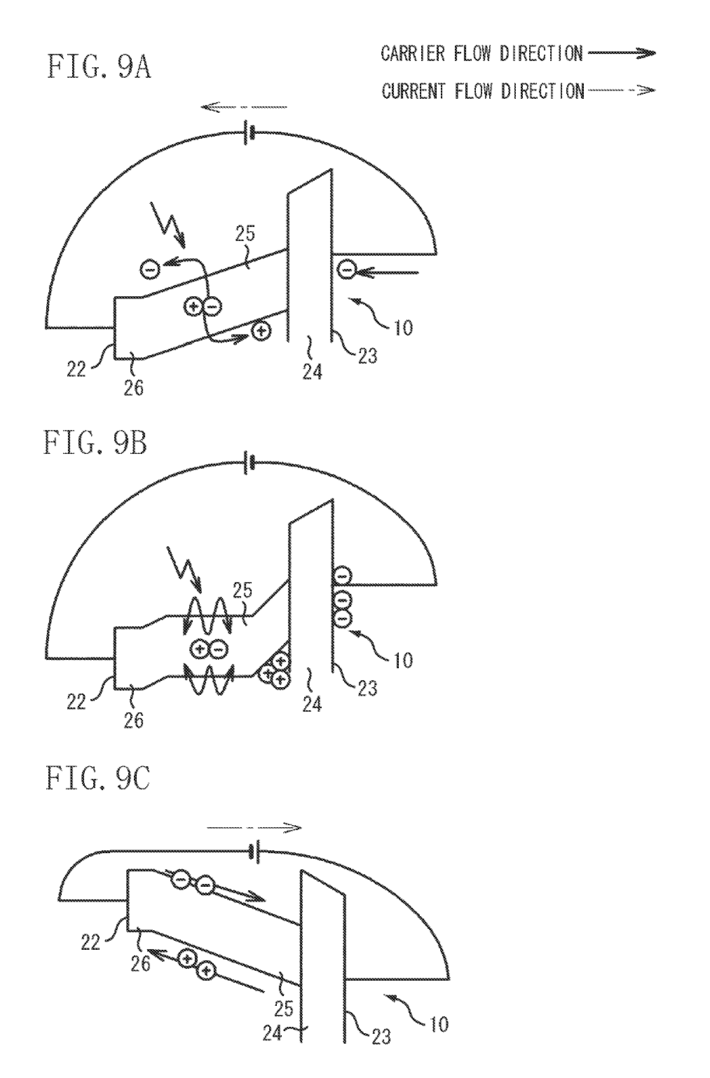

FIG. 10 is a timing chart.

### DESCRIPTION OF THE EMBODIMENTS

Various exemplary embodiments, features, and aspects of the invention will be described in detail below with reference to the drawings.

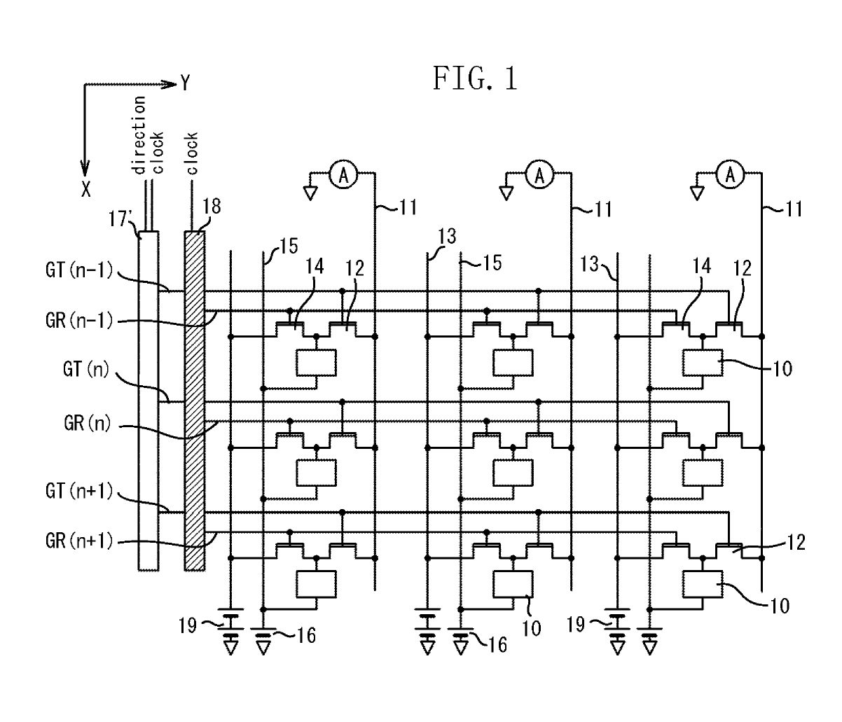

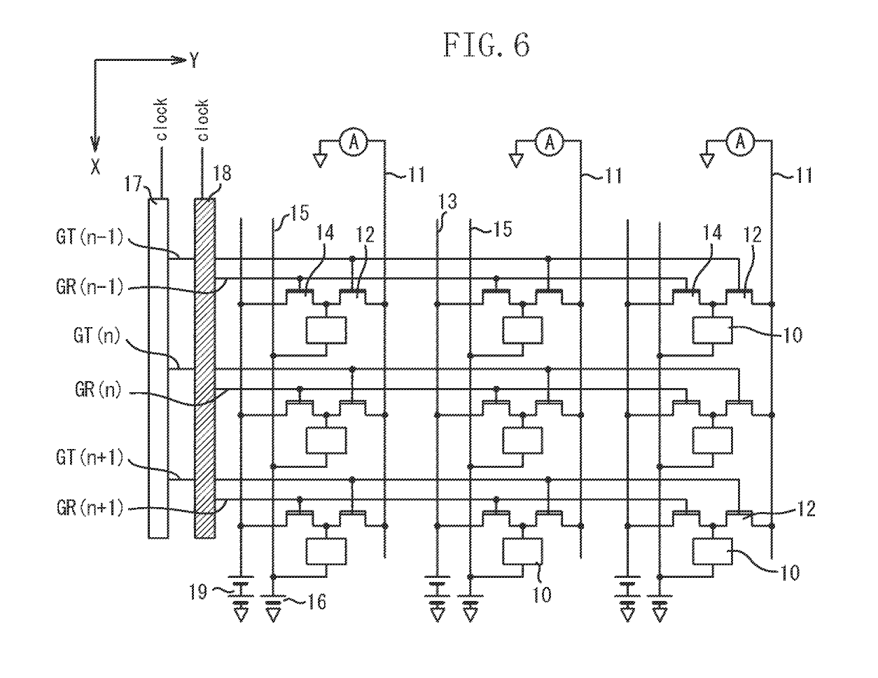

An exemplary embodiment of the present invention will be described in detail below with reference to FIGS. 1 to 5. FIG. 1 illustrates an example circuit configuration of an FPD, which is a metal-insulator-semiconductor (MIS) sensor for example. Throughout the drawings, the same reference numerals as those of FIG. 6 denote the similar components to those of FIG. 6.

The FPD includes a number of pixels 10 that are two dimensionally arranged along the x and y coordinates. Each of the pixels 10 is connected with two switches 12 and 14, and a bias voltage and a refresh voltage are applied thereto as in the conventional example of FIG. 6, which will not be described below. A shift register 17′ includes a direction bit for specifying a shift direction.

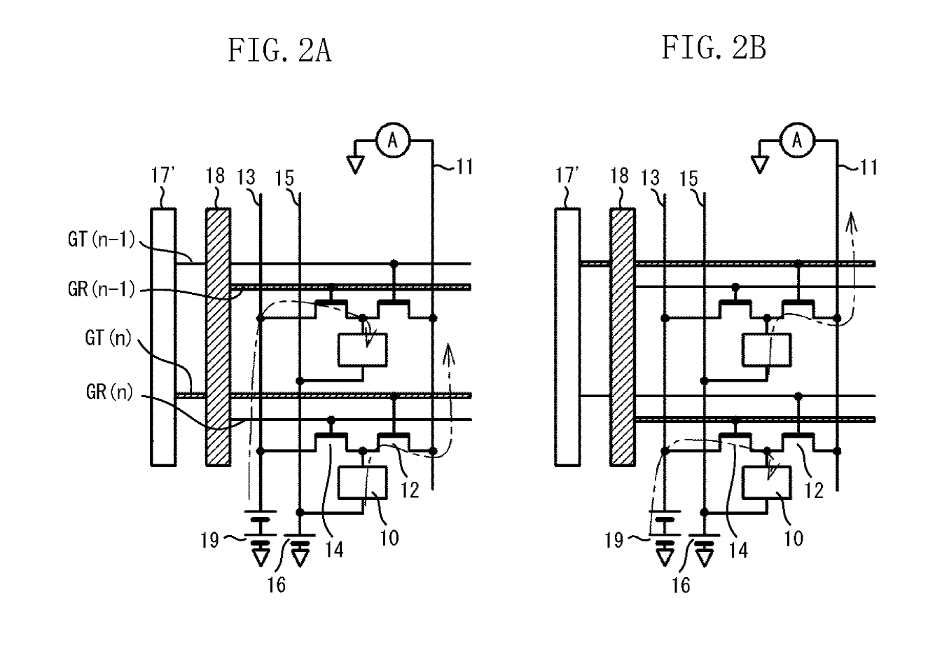

FIGS. 2A and 2B illustrate the principle of the present invention. As illustrated, an operation using the read switch 12 and an operation using the refresh switch 14 can be performed simultaneously on the reading lines of the pixels 10 in different rows.

FIG. 2A illustrates that the read of the row n and the refresh of the row (n−1) are performed simultaneously. Since the read switches 12 are turned on in one row only, the current flowing through the reading line 11 comes from the light signals of the pixels 10 in the row, which can be precisely read even if a refresh is performed on another row.

FIG. 2B illustrates that the refresh of the row n and the photoelectric conversion mode setting of the row (n−1) are performed simultaneously. The photoelectric conversion mode setting that involves application of the same electric field as that for read can be performed simultaneously with refresh of another row.

To the contrary, for different reading lines 11 (the row n and the row (n−1)), for example, a reading and a photoelectric conversion mode setting cannot be performed simultaneously. These require the operations of the read switches 12 in different rows simultaneously, which mixes the currents for photoelectric conversion mode setting and for reading, resulting in incorrect separation of light signals.

In addition, simultaneously turning on the refresh switches 14 and the read switches 12 in one row results in a short circuit of the refresh voltage, leading to ineffective operations on the pixels 10. Consequently, different operations in different rows are effective simultaneously.

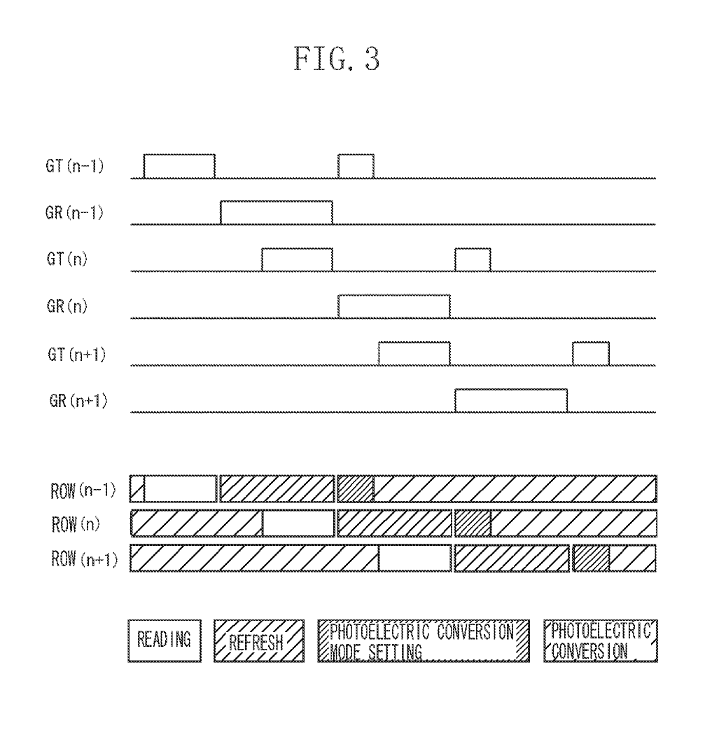

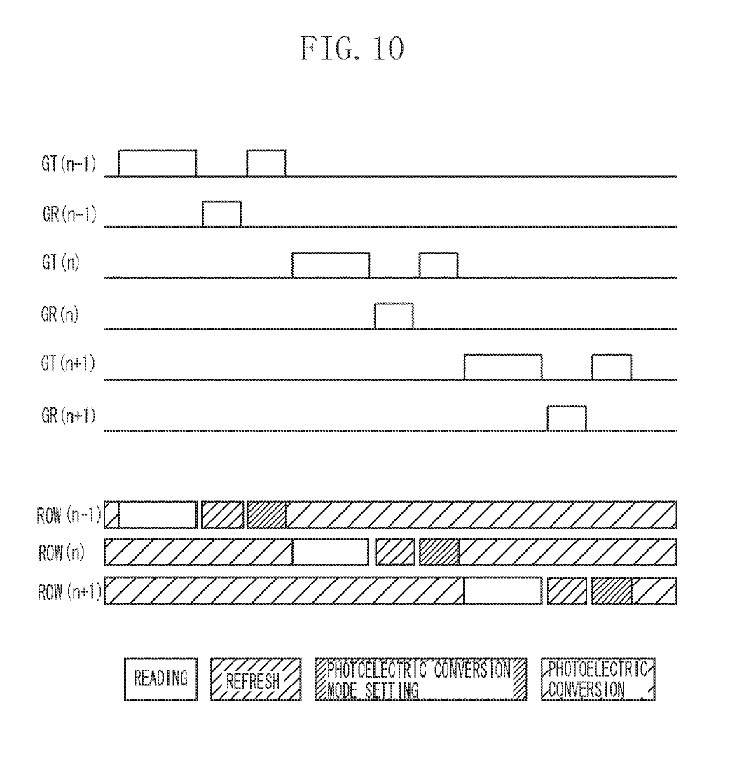

FIG. 3 is a timing chart illustrating the driving of the FPD. In contrast to the conventional timing chart of FIG. 10, there are a period of time when the read control line GT (n) and the refresh control line GR (n−1) are turned on simultaneously, and a period of time when the refresh control line GR (n) and the read control line GT (n−1) are turned on simultaneously.

During the former period, as in FIG. 2A, the read of the row n and the refresh of the row (n−1) are performed simultaneously, whereas during the latter period, as in FIG. 2B, the refresh of the row n and the photoelectric conversion mode setting of the row (n−1) are performed simultaneously.

As illustrated as the bottom bars for three rows in FIG. 3, a read, a refresh, and a photoelectric conversion mode setting are performed on each of the rows, indicating that the operations can work appropriately as the scan of the FPD.

The operations of FIG. 3 each can take a time period equal to or longer than those of FIG. 10, respectively. Moreover, as can be seen from the comparison of FIG. 3 with FIG. 10 about the starting times of the read of corresponding rows, the scan rate is improved in FIG. 3.

In comparison of the order of the read control lines GT to be turned on in the conventional timing chart in FIG. 10 with those of the exemplary embodiment in FIG. 3, one read control line GT is often turned on twice in the conventional example.

The operation, however, proceeds from the read control line GT (n−1) to the read control line GT (n), and never in the reverse order. In other words, the row number of the selected read control line GT is monotonically increasing, and the shift direction is controlled by the shift register 17 only in one way.

In the timing chart in FIG. 3, the read control line GT (n) is turned on for read of the row n, and next the read control line GT (n−1) is turned on to cause the row (n−1) to enter the read mode. Then, the read control line GT (n+1) is turned on for reading the row (n+1). In other words, the row number of the selected read control line GT is neither monotonically increasing nor decreasing, and the shift direction is frequently switched during a scan.

To achieve such scan, the shift register 17′ includes a direction bit for specifying a shift direction as described above. The shift register 17′ is a read-control-line drive circuit of the FPD of the present exemplary embodiment. A complex scan that proceeds neither monotonically forward nor backward can be achieved by switching the direction bit to a right shift or a left shift during a scan, and inputting clock pulses.

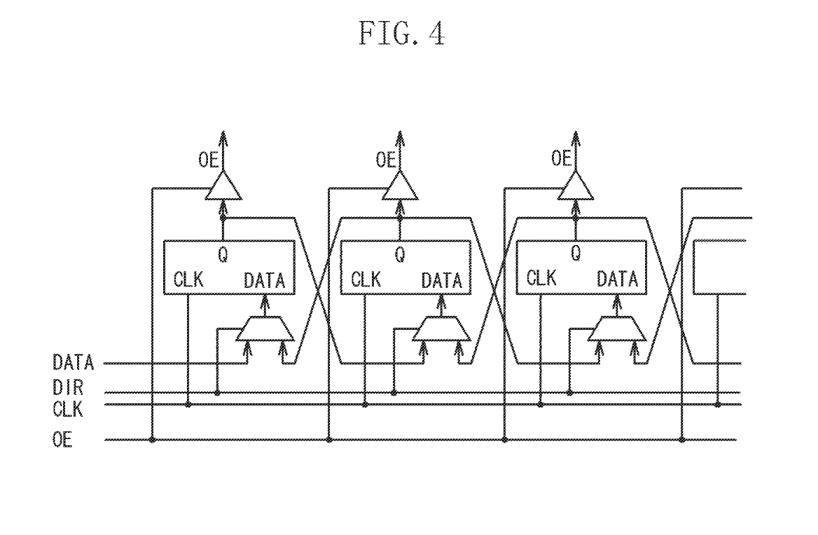

FIG. 4 is a circuit diagram illustrating the shift register 17′ of the present exemplary embodiment. The shift register 17′ includes shift direction specification DIR, shift clock CLK, and output enable OE. The shift register 17′ is configured with a plurality of registers. One single register, every time a pulse is input to the shift clock CLK, takes in the output on the right/left side thereof according to the specification of the shift direction specification DIR, and outputs the content.

The signals of the shift direction specification DIR and the shift clock CLK are commonly input to every register, which enables a right/left shift as a whole. While the output enable OE is set OFF, the entire output of the shift register 17′ is set OFF irrespective of the setting of individual registers, which prevents an accidental activation of a bit in the middle of a shift.

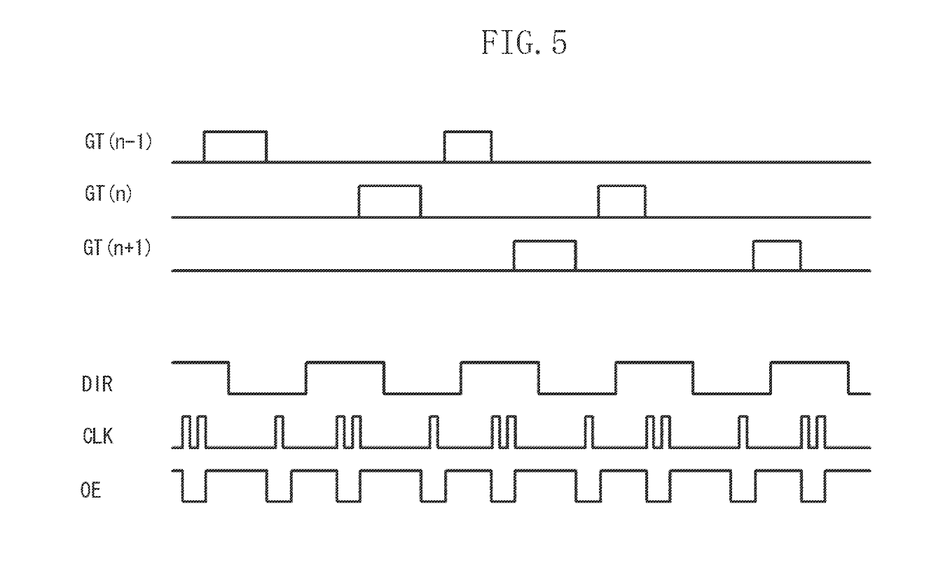

FIG. 5 illustrates row selection waveforms of read control lines GT using the shift register 17′. While a right shift or a left shift is selected according to the shift direction specification DIR, a shift clock CLK is input, so that the row selection is determined to the right or left.

To turn on a certain read control line GT actually, the output enable OE is turned on. In the present exemplary embodiment, a pulse of the shift clock CLK is input under the shift direction specification DIR of L so that one previous row is selected, whereas two pulses of the shift clock CLK are input under the shift direction specification DIR of H so that a row which is two rows ahead is selected.

As described above, the FPD of the present exemplary embodiment uses the shift register 17′, which can shift bidirectionally, for selection of the read control lines GT, and thereby the read control lines GT (n) can be selected in random order, not monotonically increasing order.

The above configuration allows a read control line GT (n) to be selectively pulsed for reading, and then the read control line GT (n−1) to be selectively pulsed for a read mode setting. While the read control line GT (n) is not selected, a refresh can be performed on the row n.

Thus, while the read control line GT (n+1) or the read control line GT (n−1) is selected, a shift register 18, which is a refresh-control-line drive circuit, selects the refresh control line GR (n), which achieves the simultaneous read and refresh operations, or refresh and read mode setting operations. The above configuration and procedure reduces the period for scanning the FPD.

In the present exemplary embodiment, a single row is selected at a time. Then a read control line GT repeatedly proceeds two lines and back a line. But, a plurality of rows may be selected in one selection to obtain the same effect.

For example, when two rows are selected at one time, two previous read control lines GT and then the read control lines GT, which are four lines ahead from there are repeatedly selected to obtain the same effect.

The above configuration is now described specifically using a function. The read switches 12 (x, y) are each connected to every pixel (x, y) of the semiconductor image sensor array. The read control line GT (x) controls all of the read switches 12 arranged along the y coordinate for a certain x coordinate simultaneously. The refresh switches 14 (x, y) are each connected to every pixel (x, y) as pairs with the read switches 12 (x, y).

The refresh control line GR (x) controls all of the refresh switches 14 arranged along the y coordinate for a certain x coordinate simultaneously. The shift register 17′ drives the read control line GT (x), whereas the shift register 18 drives the refresh control line GR (x).

As a first set, the shift register 17′ selects a read control line GT (x) and drives, selects and drives a read control line GT (x−m: m is a natural number), and then selects and drives a read control line GT (x+m), and repeatedly operates the first set in succession.

The shift register 18 controls a refresh control line GR (x) to drive refresh switches 14 (x, y) sequentially. For example, while the shift register 18 controls one operation, the shift register 17′ controls two operations.

That is, as a second set, the shift register 18 selects and drives the refresh control line GR (x−m) while the read control line GT (x) is selected, and selects the refresh control line GR (x) while the read control line GT (x−m) and the read control line GT (x+m) are selected, and repeatedly operates the second set in succession.

The bidirectional shift register 17′ is used to select a read control line GT (n) in the present exemplary embodiment, but an address decoder that selects a certain row based on a row number may be used instead.

The simultaneous read and refresh operation, and the simultaneous refresh and read mode setting operation are performed in the present exemplary embodiment, but only one of the operations contributes to the reduction of the scan period.

The present invention, which is useful to read an array of sensors sequentially, is applied to an FPD having two dimensionally arrayed sensors in the above exemplary embodiment, but is applicable to read a single array of sensors. The semiconductor image sensor may be a TFT.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

1. A radiation detector comprising:
photoelectric conversion elements arranged in a matrix including rows and columns;
column signal lines provided per column and each shared by at least two photoelectric conversion elements among the photoelectric conversion elements;
read switches respectively provided for the photoelectric conversion elements and each configured to connect each of the photoelectric conversion elements to one of the column signal lines;
a scanning circuit configured to control the read switches; and
a control unit configured to control the scanning circuit to execute an accumulation process for accumulating charge by turning off the read switches, and an output process for outputting the charge accumulated in photoelectric conversion elements arranged in a row of the matrix via the column signal lines by turning on multiple read switches of the read switches corresponding to the row,
wherein the control unit is configured to execute, by controlling the scanning circuit, a first control for outputting charge by sequentially performing the output process on neighboring rows (GT (n)→GT (n+1)), and a second control for outputting charge by, performing (1) the output process on a row, skipping (2) the output process on a row neighboring the row after the performing (2) and performing (3) the output process on a row different from the row neighboring the row (GT GT (n−1)→GT (n+1)).

2. The radiation detector of claim 1, wherein the scanning circuit includes a shift register configured to sequentially output a signal to a connected row signal line, and an output stopping unit configured to stop output of the signal to the row signal line.

3. The radiation detector of claim 1, wherein the control unit is configured to bring the photoelectric conversion elements into a state of simultaneously accumulating charge, by performing the accumulation process.

4. The radiation detector of claim 1, wherein if the photoelectric conversion elements are arranged in the radiation detector in first to N-th rows in this order, if N is a natural number larger than one, and if n and m are natural numbers satisfying relationship expressed as n>m, the control unit is configured to perform, after performing the output process on a photoelectric conversion element in an (n−m)-th row, the output process on a photoelectric conversion element in an (n+m)-th row without performing the output process on a photoelectric conversion element in an n-th row.

5. The radiation detector of claim 4, wherein the control unit is configured to perform, after performing the output process on a photoelectric conversion element in an (n+m)-th row, the output process on a photoelectric conversion element in an n-th row.

6. The radiation detector of claim 1, wherein the control unit is configured to simultaneously perform the output process on rows.

7. The radiation detector of claim 1, wherein each of the photoelectric conversion elements includes an accumulation electrode and a second electrode.

8. The radiation detector of claim 7, wherein one of the read switches is connected to the accumulation electrode and a power source is connected to the second electrode.

9. The radiation detector of claim 1, wherein each of the photoelectric conversion elements is connected to different one of the read switches at one end and to a power source at the other end.

10. The radiation detector of claim 1, wherein the scanning circuit includes either a shift register or an address decoder.

11. The radiation detector of claim 1, wherein the control unit is configured to perform the output process on each row in a predetermined order, thereby performing radiation moving image shooting.

12. The radiation detector of claim 1, further comprising other switches respectively provided for the photoelectric conversion elements and the other switches configured to connect a predetermined power source.

13. The radiation detector of claim 12, wherein the photoelectric conversion elements recover their sensitivity to light in response to being respectively connected to the predetermined power source via the other switches.

14. The radiation detector of claim 12, wherein the control unit is configured to perform in parallel output of charge by the read switches and connection of the photoelectric conversion elements to the predetermined power source by the other switches, while reading one frame.

15. The radiation detector of claim 1, wherein the control unit is configured to execute, while reading one frame, control for reading charge by sequentially performing the output process on neighboring rows, and control for skipping, after performing the output process on a row, the output process on a row neighboring the row and performing the output process on a row different from the row neighboring the row.

16. A method for controlling a radiation detector including photoelectric conversion elements arranged in a matrix including rows and columns, column signal lines provided per column and each shared by at least two photoelectric conversion elements among the photoelectric conversion elements, read switches respectively provided for the photoelectric conversion elements and each configured to connect each of the photoelectric conversion elements to one of the column signal lines, and a scanning circuit configured to control the read switches, the method comprising:
a first control step for outputting charge by sequentially performing the output process on neighboring rows (GT (n)→GT (n+1)); and
a second control step for outputting charge by, performing (1) an output process on a row, skipping (2) the output process on a row neighboring the row after the performing (2) and performing (3) the output process on a row different from the row neighboring the row (GT GT (n−1)→GT (n+1)),
wherein the output process is for outputting the charge accumulated in photoelectric conversion elements arranged in a row of the matrix via the column signal lines by turning on multiple read switches of the read switches corresponding to the row.
